(19) United States
(12) Patent Application Publication
(10) Pub. No.: US 2020/0386713 A1
(43) Pub. Date: Dec. 10, 2020

(54) ION MOBILITY SPECTROMETER

(71) Applicant: SHIMADZU CORPORATION, Kyoto-shi, Kyoto (JP)

(72) Inventor: Yoshinori ARITA, Kyoto-shi (JP)

(73) Assignee: SHIMADZU CORPORATION, Kyoto-shi, Kyoto (JP)

(21) Appl. No.: 16/607,287

(22) PCT Filed: Jul. 4, 2017
(86) PCT No.: PCT/JP2017/024420

§ 371 Date: Oct. 22, 2019

(51) Int. Cl. G01N 27/62

(52) U.S. Cl. CPC G01N 27/622

(57) ABSTRACT

An output voltage of a drift power source is appropriately divided by resistive division using a ladder resistance circuit, and the resulting voltages are respectively applied to ring-shaped electrodes forming an ion transport region and a resistance tube forming a drift region. A voltage detector detects a voltage applied to the higher-potential end of the resistance tube. A feedback controller controls the output voltage so as to maintain the detected voltage at a constant level. If an ambient temperature changes during a measurement, or if the device is continuously used for a long period of time, the resistance value of the resistance tube changes, causing a corresponding change in a middle voltage. This change is suppressed by the feedback control, and the strength and potential gradient of the electric field created within the resistance tube become stable. The measurement reproducibility and resolving power can be maintained at high levels.

### TECHNICAL FIELD

The present invention relates to an ion mobility spectrometer which separates ions according to their mobilities and detects the separated ions or sends those ions to a mass spectrometry unit or similar analysis unit in the subsequent stage.

### BACKGROUND ART

When ions derived from the compounds in a sample are made to move through a medium gas (or medium liquid) by the effect of an electric field, each ion moves at a speed which is proportional to its mobility determined by the strength of the electric field, size of the ion and other factors. Ion mobility spectrometry (IMS) is a measurement method which utilizes this ion mobility for an analysis of sample molecules.

FIG. 4 is a schematic configuration diagram of a commonly used ion mobility spectrometer (see Patent Literature 1 or other related documents).

This ion mobility spectrometer includes an ion source 1 for ionizing component molecules in a liquid sample by electrospray ionization (ESI) or other methods; a plurality of ring-shaped electrodes 21 forming an ion transport region A; a plurality of ring-shaped electrodes 41 forming a drift region B; a shutter gate 3 located between the last ring-shaped electrode 21 in the ion transport region A and the first ring-shaped electrode 41 in the drift region B; a detector 6 for detecting ions; and an exit electrode 5 located between the last ring-shaped electrode 41 in the drift region B and the detector 6. It should be noted that the ring-shaped electrodes 21 and 41 in FIG. 4 are shown by their end faces at a plane of section including an ion beam axis C which is the central axis.

The ring-shaped electrodes 21 and 41 as well as the exit electrode 5 are individually connected to a ladder resistance circuit 10B including a plurality of resistors. Voltage V, which applied from a direct-current power source (not shown), is resistively divided by the resistors of the ladder resistance circuit 10B, and the resulting direct voltages are respectively applied to those electrodes. By those voltages, a direct electric field which shows a downward potential gradient in the direction of motion of the ions (rightwards in FIG. 4), i.e. which accelerates ions, is created within each of the ion transport region A and the drift region B. The potential gradient in the electric field created in the ion transport region A and the potential gradient in the electric field created in the drift region B can be appropriately regulated through the values of the resistors forming the ladder resistance circuit 10B. Meanwhile, a stream of neutral diffusion gas is formed in the direction opposite to the direction of acceleration by the electric field within the drift region B. Though not shown, a pulsed voltage is applied from another power source to the shutter gate 3.

A schematic operation of the present ion mobility spectrometer is as follows:

Various ions generated from a sample in the ion source 1 travel through the ion transport region A. Due to a potential barrier formed at the shutter gate 3, those ions are temporarily blocked in front of the shutter gate 3. Then, the shutter gate 3 is opened for a short period of time, whereupon the ions in a packet-like form are almost simultaneously introduced into the drift region B. The ions introduced into the drift region B move forward due to the accelerating electric field, colliding with the counterflowing diffusion gas. During their motion, the ions are spatially separated from each other along the ion beam axis C according to their ion mobilities which depend on their size, three-dimensional structure, number of charges and other properties. Ions having different ion mobilities have temporal differences when passing through the exit electrode 5 and reaching the detector 6. If the electric field in the drift region B is uniform, the collision cross section between each ion and the diffusion gas can be estimated from the drift time required for the ion to pass through the drift region B.

There is also a device configured so that the ions separated according to their ion mobilities in the previously described manner are not directly detected, but are subsequently introduced into a mass separator, such as a quadrupole mass filter, to further separate those ions according to their mass-to-charge ratios m/z before detecting the ions. Such a device is known as ion mobility-mass spectrometers (IMS-MS).

In the example shown in FIG. 4, a structure formed by stacking ring-shaped electrodes 21 or 41 (normally, a structure formed by alternately stacking ring-shaped electrodes and ring-shaped insulating spacers) is used in order to create an electric field for driving ions in each of the ion transport region A and the drift region B. The technique for creating an electric field by using such a structure is called the “stack type” in the present description.

Patent Literature 2 and other related documents disclose an ion mobility spectrometer in which a resistance tube consisting of a cylindrical glass tube with its inner circumferential surface coated with a resistive film layer (see Non-Patent Literature 1 or other related documents) is used in place of the plurality of ring-shaped electrodes. FIG. 5 is a schematic configuration diagram of such an ion mobility spectrometer.

In this ion mobility spectrometer, a uniform electric field for accelerating ions can be created within the resistance tubes 2 and 4 by applying a predetermined amount of direct voltage between the two ends of a resistance tube 2 for the ion transport region A as well as between the two ends of another resistance tube 4 for the drift region B. In this case, since the resistance tubes 2 and 4 themselves are resistance elements, the ladder resistance circuit 10C can be considered as having a configuration in which virtual resistors that respectively correspond to the resistance tubes 2 and 4 are present, as shown in FIG. 5. The technique for creating an electric field by using such a structure is called the “resistance tube type” in the present description.

Similar to the stack type of ion mobility spectrometer, the resistance tube type of ion mobility spectrometer allows for the reduction of the number of power sources by resistively dividing a voltage applied from a direct-current power source using the ladder resistance circuit 10C, and applying the resulting voltages to the resistance tube 2 for the ion transport region A and the resistance tube 4 for the drift region B.

However, there is the following problem with both the stack type and the resistance tube type.

The resistance value between the two ends of a commercially available resistance tube shows a comparatively large amount of variation depending on the ambient temperature under which the tube is used, the period of time of the continuous use, and other factors. FIG. 6 is a diagram showing the result of a measurement of a resistance value between the two ends of a commercially available resistance tube. The condition that the temperature is increased to 150 degrees Celsius is to simulate an actual use condition of the resistance tube in an ion mobility spectrometer. The resistance value decreased to nearly one half of the value recorded under the initial condition (room temperature). After the tube had been continuously used for approximately 1000 hours, the resistance value increased to more than two times the value recorded at the beginning of the temperature increase. A likely cause of the latter problem is the adhesion of the components in the air (or other substances) to the resistive film layer of the resistance tube.

In the ion mobility spectrometer shown in FIG. 5, if the resistance value of the resistance tube 4 changes depending on the temperature or due to a temporal change in the previously described manner, the voltage applied between the two ends of the resistance tube 4 changes, and the strength of the electric field within the drift region B also changes. This causes a change in the speed of the ions passing through the drift region B, and eventually lowers the performance of the device, such as the measurement reproducibility or resolving power.

On the other hand, in the stack type of ion mobility spectrometer as shown in FIG. 4, among the resistors included in the ladder resistance circuit 10B, a group of resistors for distributing voltages to a plurality of ring-shaped electrodes 41 forming the drift region B is separated from a group of resistors for distributing voltages to a plurality of ring-shaped electrodes 21 forming the ion transport region A. The former group of resistors are normally located close to the drift region B. Since the ring-shaped electrodes 41 forming the drift region B are maintained at high temperatures of 150-200 degrees Celsius during the measurement, the resistors for distributing voltages to those ring-shaped electrodes 41 are also heated to considerably high temperatures. By comparison, the ambient temperature around the resistors for distributing voltages to the ring-shaped electrodes 21 forming the ion transport region A is considerably low. Therefore, a discrepancy in the amount of change in the resistance value due to the temperature occurs between the ion transport region A and the drift region B. This leads to a change in the voltage applied between the first and last electrodes of the ring-shaped electrodes 41 forming the drift region B, and causes a change in the strength of the electric field within the drift region B. Consequently, the performance of the device, such as the measurement reproducibility or resolving power, may possibly deteriorate as in the case of the resistance tube type.

### CITATION LIST

### Patent Literature

Patent Literature 1: JP 2015-75348 A
Patent Literature 2: U.S. Pat. No. 7,081,618 B

### Non Patent Literature

Non Patent Literature 1: “Resistive Glass Products ATTRACT EVERY MOLECULE”, Photonis, [online], [accessed on Jul. 3, 2017], the Internet <URL: https://www.photonis.com/uploads//literature/rgp/Resistive-Glass-Product-brochure.pdf>

### SUMMARY OF INVENTION

### Technical Problem

The present invention has been developed to solve the previously described problem. Its objective is to provide an ion mobility spectrometer which can maintain the strength of the electric field within the drift region in a stable manner and thereby maintain a high level of device performance even if the ambient temperature changes or the device is used for a long period of time.

### Solution to Problem

An ion mobility spectrometer according to the first aspect of the present invention developed for solving the previously described problem includes:

a) a drift-field creating section configured to create an electric field according to an applied voltage, within a space for separating ions according to the ion mobilities of the ions;

b) an ion transport section configured to create an electric field for transporting ions of sample-component origin to the space according to an applied voltage;

c) a power source configured to generate a predetermined direct voltage;

d) a voltage distributor configured to resistively divide an output voltage of the power source into a plurality of voltages and apply the voltages to the ion transport section and the drift-field creating section, respectively;

e) a voltage detector configured to detect the voltage applied to the drift-field creating section by the voltage distributor; and

f) a controller configured to control the output voltage of the power source so as to maintain the voltage detected by the voltage detector at a predetermined value.

An ion mobility spectrometer according to the second aspect of the present invention developed for solving the previously described problem includes:

a) a drift-field creating section configured to create an electric field according to an applied voltage, within a space for separating ions according to the ion mobilities of the ions;

b) an ion transport section configured to create an electric field for transporting ions of sample-component origin to the space according to an applied voltage;

c) a power source configured to generate a predetermined direct voltage:

d) a voltage distributor configured to resistively divide an output voltage of the power source into a plurality of voltages and apply the voltages to the ion transport section and the drift-field creating section, respectively, where the resistance value of a portion of the resistors used for resistive division is adjustable: and

e) a voltage detector configured to detect the voltage applied to the drift-field creating section by the voltage distributor; and

f) a controller configured to adjust the resistance value of the adjustable resistor in the voltage distributor so as to maintain the voltage detected by the voltage detector at a predetermined value.

The ion mobility spectrometer according to the first or second aspect of the present invention may be configured as follows:

at least one of the drift-field creating section and the ion transport section is an array of ring-shaped electrodes arranged along the axial direction of the electrodes at predetermined intervals of space; and

the voltage distributor is configured to apply different voltages to the ring-shaped electrodes, respectively.

The ion mobility spectrometer according to the first or second aspect of the present invention may be configured as follows:

at least one of the drift-field creating section and the ion transport section is a tubular resistance element within which a space for allowing ions to pass through is formed; and

the voltage distributor is configured to apply a voltage between the two ends of the tubular resistance element.

That is to say, both the drift-field creating section and the ion transport section may be a stack type, or both sections may be a resistance tube type. It is also possible to adopt a stack type of configuration for one section and a resistance tube type of configuration for the other section.

For example, in the case where both the drift-field creating section and the ion transport section are tubular resistance elements, i.e. the resistance tubes, the resistance value of the tubular resistance element which is the drift electric field section changes if the ambient temperature around this tubular element changes or if a temporal change of the tubular element occurs due to the use for a long period of time. There will be no problem if the resistance value of the tubular resistance element in the ion transport section also changes at the same rate. However, it is normally the case that the rate of change of the resistance value of this tubular resistance element is different from that of the former tubular resistance element. Therefore, the ratio of the resistive division in the voltage distributor changes, and the voltage applied to the tubular resistance element which is the drift electric field section also changes.

In the ion mobility spectrometer according to the first aspect of the present invention, the voltage detector detects this voltage at predetermined intervals of time, for example, and sends the voltage to the controller. The controller performs a feedback control of the voltage value of the output voltage generated by the power source so as to maintain the detected voltage at a predetermined value. That is to say, for a change of the detected voltage to a higher value, the controller controls the output voltage of the power source so as to decrease the voltage according to its rate of change. Conversely, for a change of the detected voltage to a lower value, the controller controls the output voltage of the power source so as to increase the voltage according to its rate of change. By such a feedback control, the voltage applied to the tubular resistance element which is the drift-field creating section is maintained at a practically constant value. Therefore, the strength and potential gradient of the electric field created by the drift-field creating section will be maintained in a stable manner without being affected by the ambient temperature or temporal change.

On the other hand, in the ion mobility spectrometer according to the second aspect of the present invention, the resistance value of a portion of the resistors used for the voltage distribution by resistive division in the voltage distributor is configured to be adjustable. Instead of controlling the power source, the controller adjusts the resistance value of the adjustable resistor so that the voltage detected by the voltage detector will be maintained at a predetermined value. By this operation, the strength and potential gradient of the electric field created by the drift-field creating section can be maintained in a stable manner without being affected by the ambient temperature or temporal change, as in the ion mobility spectrometer according to the first aspect of the present invention.

As for the method for adjusting the resistance value, an appropriate method may be adopted, such as a method in which an operation element (e.g. a rod) for changing the resistance value in an analogue variable resistor is mechanically driven, or a method in which a number of resistors are switched by means of a switching element.

The ion mobility spectrometer according to the present invention may be a device in which ions separated from each other according to their mobilities are directly detected, or a device in which ions separated from each other according to their mobilities are further separated from each other by a mass analyzer, such as a quadrupole mass filter, according to their mass-to-charge ratios before being detected.

That is to say, as one mode for carrying out the present invention, the ion mobility spectrometer may further include a detector configured to detect ions exiting from the space within which the electric field is created by the drift-field creating section.

As another mode for carrying out the present invention, the ion mobility spectrometer may further include a mass spectrometry section configured to receive ions exiting from the space within which the electric field is created by the drift-field creating section, and to detect the ions after separating the ions according to the mass-to-charge ratios of the ions.

### Advantageous Effects of Invention

By the ion mobility spectrometer according to the present invention, even when the ambient temperature is changed, or even when the device is used for a long period of time, the strength and potential gradient of the electric field within the drift region which affect the moving speed of the ions can be maintained in a stable manner. As a result, the measurement reproducibility, resolving power and other performances can be maintained at high levels.

### BRIEF DESCRIPTION OF DRAWINGS

FIG. 1 is a schematic configuration diagram of an ion mobility spectrometer as the first embodiment of the present invention.

FIG. 2 is a schematic configuration diagram of an ion mobility spectrometer as the second embodiment of the present invention.

FIG. 3 is a schematic configuration diagram of an ion mobility spectrometer as the third embodiment of the present invention.

FIG. 4 is a schematic configuration diagram of a commonly used stack type of ion mobility spectrometer.

FIG. 5 is a schematic configuration diagram of a commonly used resistance tube type of ion mobility spectrometer.

FIG. 6 is a diagram showing the result of a measurement of a resistance value between the two ends of a commonly available resistance tube.

### DESCRIPTION OF EMBODIMENTS

### First Embodiment

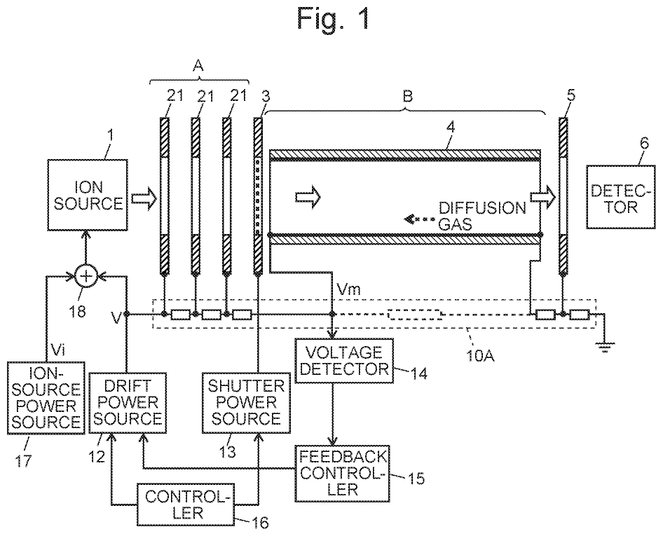

An ion mobility spectrometer according to the first embodiment of the present invention is hereinafter described with reference to FIG. 1.

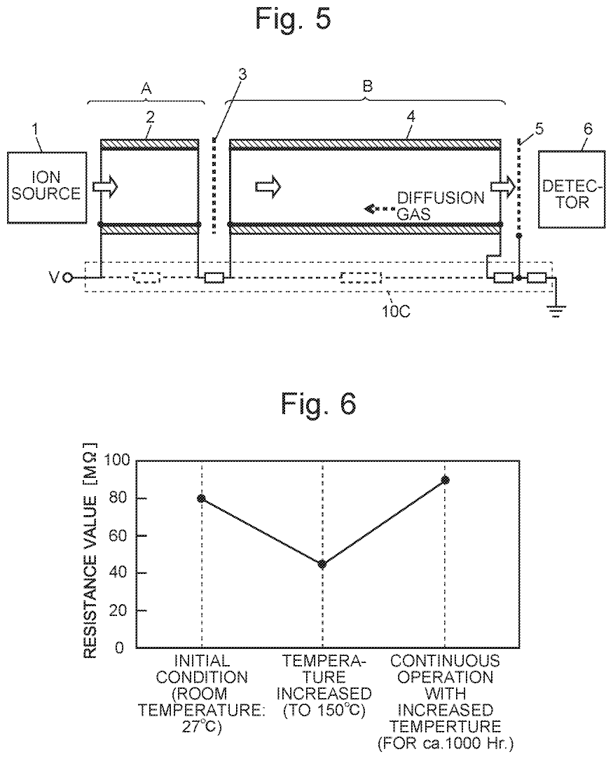

FIG. 1 is a schematic configuration diagram of the ion mobility spectrometer according to the present embodiment. In FIG. 1, the components which are identical to those shown in the already described FIGS. 4 and 5 are denoted by the same reference signs.

In the ion mobility spectrometer according to the first embodiment, the ion transport region A is formed by a plurality of ring-shaped electrodes 21, while the drift region B is formed by a resistance tube 4. In other words, the ion transport region A has a stack-type configuration, while the drift region B has a resistance-tube-type configuration. As noted earlier, the resistance tube 4 itself is a resistance element. Therefore, the ladder resistance circuit 10A for applying voltages to the ring-shaped electrodes 21 and the resistance tube 4 can be regarded as including a virtual resistor due to the resistance tube 4 (the resistance indicated by the dashed line in FIG. 1). This also applies in the second embodiment.

One end of the ladder resistance circuit 10A is grounded, while a direct voltage having voltage value V is applied from the drift power source 12 to the other end. That is to say, the output voltage of the drift power source 12 is resistively divided by the ladder resistance circuit 10A into fractions of voltage, which are respectively applied to the plurality of ring-shaped electrodes 21 and the resistance tube 4. Meanwhile, a pulsed voltage is applied from a shutter power source 13 to the shutter gate 3. A voltage generated by an adder 18 which totals the output voltage V of the drift power source 12 and the output voltage Vi of an ion-source power source 17 is applied to the ion source 1. The drift power source 12 and the shutter power source 13 are individually controlled by a controller 16. The ion-source power source 17 is a floating power source. A voltage detector 14 detects the voltage applied to the higher-potential end of the resistance tube 4 (this voltage is hereinafter called the “middle voltage”) and sends the detection result to a feedback (FB) controller 15. The feedback controller 15 performs a mathematical calculation corresponding to the voltage detection result it has received, and controls the drift power source 12 to adjust its output voltage.

The output voltage V of the drift power source 12 is normally as high as a few kV to tens of kV, and the voltage applied to the ion source 1 must be higher than those levels (approximately 4 to 5 kV for anion source which employs electrospray ionization). If the ion-source power source is solely used for generating such a high voltage, the power source will be considerably large and heavy, and its cost will also be high. By comparison, in the present ion mobility spectrometer, the output voltage of the drift power source 12 and that of the ion-source power source 17 are added and applied to the ion source 1 in the previously described manner. The ion-source power source 17 only needs to generate a voltage that is purely needed for the ionization in the ion source 1. This helps lowering the cost of the power source as well as reducing the size and weight of the power source.

The measurement operation for separating ions of sample-component origin according to their mobilities in the ion mobility spectrometer according to the present embodiment is the same as in the already described conventional device. Therefore, description of the operation will be omitted.

Hereinafter, a feedback control of the drift voltage which is characteristic of the ion mobility spectrometer according to the present embodiment is described.

During a measurement performed in the previously described manner, the voltage detector 14 detects a voltage at predetermined intervals of time, for example.

Now, suppose that the voltage value of the middle voltage detected at the beginning of the measurement is Vm. Suppose also that the resistance value of the resistor located between the resistance tube 4 and the exit voltage 5 in the ladder resistance circuit 10A as well as that of the resistor located between the exit electrode 5 and the grounded end are both sufficiently smaller than the resistance value R of the resistance tube 4 and ignorable (i.e. they can be regarded as zero). The serial resistance value of the resistors located between the first ring-shaped electrode 21 and the resistance tube 4 is r. Then, the voltage value Vm of the middle voltage is expressed by the following equation (1):

Vm=V·{R/(r+R)} (1)

Consider a situation in which the resistance value R of the resistance tube 4 has changed to R′ due to some factors, such as a change in the ambient temperature, causing the voltage value Vm of the middle voltage to change to Vm′. The feedback controller 15 recognizes this change in voltage based on the voltage detection result obtained by the voltage detector 14, and controls the drift power source 12 so as to change its output voltage according to the amount of change in the voltage. Specifically, the drift power source 12 is controlled so that the voltage value V of the output voltage changes to the voltage value V′ given by the following equation (2):

V′=V·(Vm/Vm′) (2)

According to this feedback control, the drift power source 12 changes its output voltage. The middle voltage returns from Vm′ to Vm, and the voltage between the two ends of the resistance tube 4 is maintained at a constant value. Consequently, the strength and potential gradient of the electric field created by the resistance tube 4 is maintained in a stable manner without being affected by the temperature change or temporal change.

### Second Embodiment

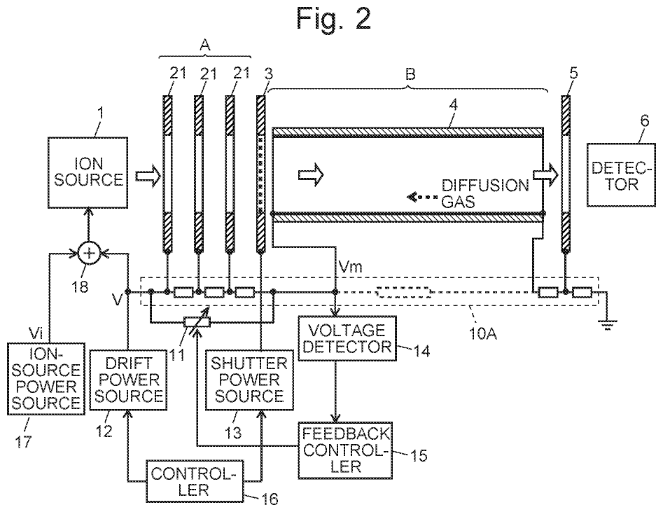

FIG. 2 is a schematic configuration diagram of an ion mobility spectrometer according to the second embodiment. In FIG. 2, the components which are identical to those shown in the already described FIGS. 1, 4 and 5 are denoted by the same reference signs.

The differences from the ion mobility spectrometer according to the first embodiment will be hereinafter described. In the ion spectrometer according to the second embodiment, a variable resistor 11 whose resistance value can be electrically adjusted is connected between the two ends of the series circuit of a plurality of resistors (i.e. the previously mentioned resistors whose serial resistance value is r) located between the first ring-shaped electrode 21 and the resistance tube 4 in the ladder resistance circuit 10A. The feedback controller 15 is configured to control the resistance value of the variable resistor 11 instead of controlling the drift power source 12.

Consider a situation in which the resistance value R of the resistance tube 4 has changed to R′ due to some factors, such as a change in the ambient temperature, causing the voltage value Vm of the middle voltage to change to Vm′. This voltage value Vm′ can be expressed by the following equation (3):

Vm′=V·R′/(r+R′) (3)

Rewriting this equation gives the following equation (4):

R′=r/{(V/Vm′)−1} (4)

In order to restore the original voltage value Vm by changing the resistance value r to r′, the ratio of the resistive division needs to satisfy the following equation (5):

R/(r+R)=R′/(r′+R′) (5)

Rewriting this equation gives the following equation (6):

r′=r×(R′+R) (6)

So, the resistance value r′ can be set as follows:

r′=r²/[R·{(V/Vm)−1}] (7)

The feedback controller 15 adjusts the resistance value of the variable resistor 11 based on the resistance value determined by calculation in the previously described manner. As a result, similar to the first embodiment, the voltage value of the middle voltage can be maintained at a substantially constant level, whereby the strength and potential gradient of the electric field created within the resistance tube 4 can be maintained in a stable manner.

In place of the aforementioned variable resistor 11 which is connected between the two ends of the series circuit of the resistors located between the first ring-shaped electrode 21 and the resistance tube 4 in the ladder resistance circuit 10A, a variable resistor may be connected parallel to the resistance tube 4. It is evident that this configuration also allows the voltage value of the middle voltage to be similarly maintained at a constant level by adjusting the resistance value of the variable resistor.

### Third Embodiment

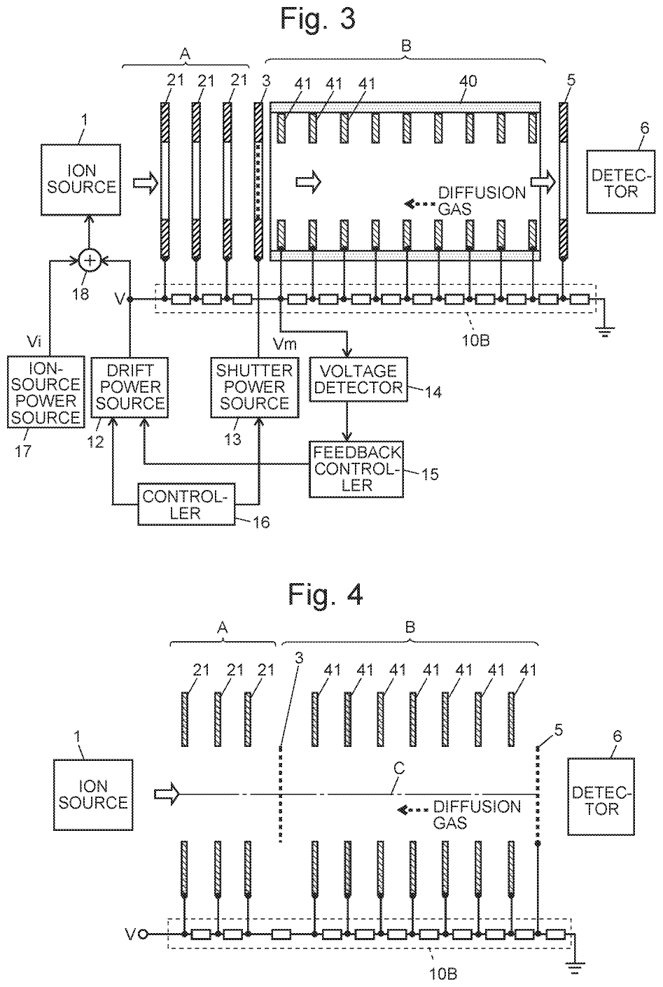

FIG. 3 is a schematic configuration diagram of an ion mobility spectrometer as the third embodiment. In this ion mobility spectrometer, the drift region B is formed by a plurality of ring-shaped electrodes 41 arranged within an insulating tube 40. That is to say, the drift region B has a stack-type configuration. This configuration can also maintain the voltage applied to the first ring-shaped electrode 41, i.e. the voltage value of the middle voltage, at a constant level by the same operation as in the first embodiment.

It is evident that the drift region B having a stack-type configuration as in the third embodiment may be combined with the configuration of the second embodiment in which the resistance value of the variable resistor 11 is regulated in place of the output voltage of the drift power source 12.

It is also evident that the ion transport region A may be formed by a resistance tube in any of the ion mobility spectrometers according to the first through third embodiments.

In the ion mobility spectrometers according to the previously described embodiments, the ions separated from each other according to their ion mobilities in the drift region B are detected with the detector 6. It is also possible to adopt a configuration in which the ions separated from each other according to their ion mobilities are introduced into a mass separator, such as a quadrupole mass filter, and further separated from each other according to their mass-to-charge ratios before being detected.

The previously described embodiments are mere examples of the present invention, and any change, modification or addition which is appropriately made within the spirit of the present invention other than those described in those embodiments and their variations will naturally fall within the scope of claims of the present application.

### REFERENCE SIGNS LIST

1 . . . Ion Source
2 . . . Resistance Tube
21 . . . Ring-Shaped Electrode
3 . . . Shutter Gate
4 . . . Resistance Tube
40 . . . Insulating Tube
41 . . . Ring-Shaped Electrode
5 . . . Exit Electrode
6 . . . Detector
10A, 10B, 10C . . . Ladder Resistance Circuit
11 . . . Variable Resistor
12 . . . Drift Power Source
13 . . . Shutter Power Source
14 . . . Voltage Detector
15 . . . Feedback (FB) Controller
16 . . . Controller
17 . . . Ion-Source Power Source
18 . . . Adder
A . . . Ion Transport Region
B . . . Drift Region
C . . . Ion Beam Axis

1. An ion mobility spectrometer, comprising:
a) a drift-field creating section configured to create an electric field according to an applied voltage, within a space for separating ions according to ion mobilities of the ions;
b) an ion transport section configured to create an electric field for transporting ions of sample-component origin to the space according to an applied voltage;
c) a power source configured to generate a predetermined direct voltage;
d) a voltage distributor configured to resistively divide an output voltage of the power source into a plurality of voltages and apply the voltages to the ion transport section and the drift-field creating section, respectively;
e) a voltage detector configured to detect the voltage applied to the drift-field creating section by the voltage distributor; and
f) a controller configured to control the output voltage of the power source so as to maintain the voltage detected by the voltage detector at a predetermined value.

2. An ion mobility spectrometer, comprising:
a) a drift-field creating section configured to create an electric field according to an applied voltage, within a space for separating ions according to ion mobilities of the ions;
b) an ion transport section configured to create an electric field for transporting ions of sample-component origin to the space according to an applied voltage;
c) a power source configured to generate a predetermined direct voltage;
d) a voltage distributor configured to resistively divide an output voltage of the power source into a plurality of voltages and apply the voltages to the ion transport section and the drift-field creating section, respectively, where a resistance value of a portion of the resistors used for resistive division is adjustable; and
e) a voltage detector configured to detect the voltage applied to the drift-field creating section by the voltage distributor; and
f) a controller configured to adjust the resistance value of the adjustable resistor in the voltage distributor so as to maintain the voltage detected by the voltage detector at a predetermined value.

3. The ion mobility spectrometer according to claim 1, wherein:
at least one of the drift-field creating section and the ion transport section is an array of ring-shaped electrodes arranged along the axial direction of the electrodes at predetermined intervals of space; and
the voltage distributor is configured to apply different voltages to the ring-shaped electrodes, respectively.

4. The ion mobility spectrometer according to claim 2, wherein:
at least one of the drift-field creating section and the ion transport section is an array of ring-shaped electrodes arranged along the axial direction of the electrodes at predetermined intervals of space; and
the voltage distributor is configured to apply different voltages to the ring-shaped electrodes, respectively.

5. The ion mobility spectrometer according to claim 1, wherein:
at least one of the drift-field creating section and the ion transport section is a tubular resistance element within which a space for allowing ions to pass through is formed; and
the voltage distributor is configured to apply a voltage between two ends of the tubular resistance element.

6. The ion mobility spectrometer according to claim 2, wherein:
at least one of the drift-field creating section and the ion transport section is a tubular resistance element within which a space for allowing ions to pass through is formed; and
the voltage distributor is configured to apply a voltage between two ends of the tubular resistance element.

7. The ion mobility spectrometer according to claim 1, further comprising:
a detector configured to detect ions exiting from the space within which the electric field is created by the drift-field creating section.

8. The ion mobility spectrometer according to claim 2, further comprising:
a detector configured to detect ions exiting from the space within which the electric field is created by the drift-field creating section.

9. The ion mobility spectrometer according to claim 1, further comprising:
a mass spectrometry section configured to receive ions exiting from the space within which the electric field is created by the drift-field creating section, and to detect the ions after separating the ions according to mass-to-charge ratios of the ions.

10. The ion mobility spectrometer according to claim 2, further comprising:
a mass spectrometry section configured to receive ions exiting from the space within which the electric field is created by the drift-field creating section, and to detect the ions after separating the ions according to mass-to-charge ratios of the ions.
